(19) United States
(12) Patent Application Publication
(10) Pub. No.: US 2025/0287039 A1
(43) Pub. Date: Sep. 11, 2025

(54) POINT CLOUD COMPRESSION METHOD AND APPARATUS

(71) Applicant: INTELLECTUAL DISCOVERY CO., LTD., Seoul (KR)

(72) Inventors: Yongjo AHN, Seoul (KR); Jongseok LEE, Seoul (KR)

(21) Appl. No.: 18/861,188

(22) PCT Filed: Apr. 28, 2023
(86) PCT No.: PCT/KR2023/005910

§ 371 Date: Oct. 28, 2024

(30) Foreign Application Priority Data
Apr. 28, 2022 (KR) 10-2022-0053034

(51) Int. Cl. H04N 19/597; H04N 19/119; H04N 19/172; H04N 19/51

(52) U.S. Cl. CPC H04N 19/597; H04N 19/119; H04N 19/172; H04N 19/51

(57) ABSTRACT

The present invention provides a point cloud compression method and apparatus. Particularly, the point cloud compression method and apparatus may: perform global motion compensation on the basis of a frame previous to a current frame; partition the current frame into a plurality of prediction units; determine a motion compensated point within a current prediction unit by performing local motion compensation on the current prediction unit; and on the basis of the motion compensated point, determine geometric information of a current point within the current prediction unit.

### TECHNICAL FIELD

The present invention relates to an encoder and a decoder, and more particularly, to a method and device for encoding and decoding for point cloud compression.

### BACKGROUND ART

Point cloud content is content expressed as a point cloud, which is a collection of points belonging to a coordinate system expressing three-dimensional space. Point clouds can express three-dimensional media and can be used to provide various services such as VR (Virtual Reality), AR (Augmented Reality), MR (Mixed Reality), XR (Extended Reality), and autonomous driving services.

Since a large amount of point data is required to express point cloud content, a method for efficiently processing this point cloud data is required.

### DISCLOSURE

### Technical Problem

The present invention proposes an inter-frame prediction method and device for compressing a point cloud.

In this case, the inter-frame prediction method proposed in the present invention aims to provide high encoding efficiency by approximating a reference point cloud into a plurality of triangles and using them for prediction.

### Technical Solution

A point cloud compression method and device for solving the above problem are provided.

A point cloud compression method and device according to one embodiment of the present disclosure may perform global motion compensation based on a previous frame of a current frame, divide the current frame into a plurality of prediction units, determine a motion compensated point within a current prediction unit by performing local motion compensation on the current prediction unit, and determine geometric information of a current point within the current prediction unit based on the motion compensated point.

A point cloud compression method and device according to one embodiment of the present disclosure may derive a predicted statistical value based on a motion compensated point included in a predefined specific area around the current point and determine the geometric information of the current point based on the predicted statistical value.

In a point cloud compression method and device according to one embodiment of the present disclosure, the geometric information of the current point may include a symbol indicating whether the current point is occupied

In a point cloud compression method and device according to one embodiment of the present disclosure, the symbol indicating whether the current point is occupied may be entropy encoded using the predicted statistical value as a probability.

In a point cloud compression method and device according to one embodiment of the present disclosure, the specific area around the current point may be defined as an area including voxels adjacent to front, back, left, right, upper, and lower sides of the current point.

In a point cloud compression method and device according to one embodiment of the present disclosure, the specific area around the current point is defined as a hexahedral area centered on the current point and including adjacent voxels adjacent to the current point.

A point cloud compression method and device according to one embodiment of the present disclosure may divide the current prediction unit into at least one triangle based on the motion compensated point and determine a point included in a plane of the divided triangle based on the motion compensated point.

A point cloud compression method and device according to one embodiment of the present disclosure may determine the geometric information of the current point based on at least one of the motion compensated point or a point included in the plane of the divided triangle.

A point cloud compression method and device according to one embodiment of the present disclosure may obtain a plurality of vertices based on a plurality of motion compensated points adjacent to edges of the current prediction unit and divide the current prediction unit into the at least one triangle by connecting the plurality of vertices.

In a point cloud compression method and device according to one embodiment of the present disclosure, the current prediction unit is divided into areas having a size of 1×1×1 based on a predefined tree structure, and the current point corresponds to a central position of an area having the size of 1×1×1.

In a point cloud compression method and device according to one embodiment of the present disclosure, the predefined tree structure includes at least one of a binary tree, a quad tree, or an oct tree.

### Technical Effect

The point cloud compression method and device according to the present invention can improve the video signal coding efficiency.

In addition, the encoding efficiency can be improved by approximating the reference point cloud according to the present invention into a plurality of triangles and using them for inter-frame prediction.

### DESCRIPTION OF DRAWINGS

FIG. 1 is a block diagram illustrating an example of a point cloud encoder according to one embodiment of the present disclosure.

FIG. 2 is a block diagram illustrating an example of a point cloud decoder according to one embodiment of the present disclosure.

FIG. 3 is a block diagram showing an example of a geometric information encoding unit according to one embodiment of the present disclosure.

FIG. 4 is a block diagram showing an example of a geometric information decoding unit according to one embodiment of the present disclosure.

FIG. 5 is a drawing showing an example of expressing a point in three-dimensional space in two dimensions according to one embodiment of the present disclosure.

FIG. 6 is a diagram showing an example of statistical value prediction of a surrounding point performed by an intra-frame prediction unit according to one embodiment of the present disclosure.

FIG. 7 is a diagram showing an example of local motion compensation performed in an inter-frame prediction unit according to one embodiment of the present disclosure.

FIG. 8 is a diagram showing an example of a method for generating a predicted statistical value using motion-compensated points in an inter-frame prediction unit according to an embodiment of the present disclosure.

FIG. 9 is a diagram illustrating an example of a method for generating a predicted statistical value using motion-compensated points in an inter-frame prediction unit according to one embodiment of the present disclosure.

FIG. 10 is a diagram showing an example of a method for generating a predicted statistical value using motion compensated points in an inter-frame prediction unit according to an embodiment of the present disclosure.

FIG. 11 is a diagram showing an example of a method for generating a triangle for inter-frame prediction according to one embodiment of the present disclosure.

FIG. 12 is a diagram showing an example of a method for generating a predicted statistical value using motion-compensated points in an inter-frame prediction unit according to an embodiment of the present disclosure.

FIG. 13 is a diagram showing an example of a method for generating a predicted statistical value using motion-compensated points in an inter-frame prediction unit according to an embodiment of the present disclosure.

FIG. 14 is a flowchart illustrating a point cloud compression method according to one embodiment of the present disclosure.

### MODE

An embodiment of the present disclosure will be described in detail so that those skilled in the art may easily implement it by referring to a drawing attached to this specification. But, the present disclosure may be implemented in different forms and it is not limited to an embodiment described herein. And, a part irrelevant to a description is omitted to clearly describe the present disclosure in a drawing and a similar reference numeral is attached to a similar part throughout this specification.

Throughout this specification, when a part is referred to as being ‘connected’ to other part, it may include an electrical connection that other element presents therebetween as well as a direct connection.

In addition, when a part is referred to as ‘including’ a component throughout this specification, it means other component may be further included without excluding other component unless otherwise opposed.

In addition, a term such as first, second, etc. may be used to describe a variety of components, but the components should not be limited by the terms. The terms are used only to distinguish one component from other component.

In addition, for an embodiment about a device and a method described in this specification, some configurations of a device or some steps of a method may be omitted. In addition, order of some configurations of a device or some steps of a method may be changed. In addition, other configuration or other step may be inserted into some configurations of a device or some steps of a method.

In addition, some configurations or some steps of a first embodiment of the present disclosure may be added to a second embodiment of the present disclosure or may substitute some configurations or some steps of a second embodiment.

In addition, construction units shown in an embodiment of the present disclosure are independently shown to represent different characteristic functions, and they do not mean that each construction unit is configured with separated hardware or one software construction unit. In other words, each construction unit is described by being enumerated as each construction unit for convenience of a description and at least two construction units of each construction unit may be combined to form one construction unit or one construction unit may be partitioned into a plurality of construction units to perform a function. An integrated embodiment and separated embodiment of each construction unit are also included in a scope of a right of the present disclosure unless they are departing from the spirit of the present disclosure.

First, terms used in this application may be briefly described as follows.

A decoding device (Video Decoding Apparatus) to be described later may be a device included in a server terminal such as a civil security camera, a civil security system, a military security camera, a military security system, a personal computer (PC), a notebook computer, a portable multimedia player (PMP), a wireless communication terminal, a smart phone, a TV application server and a service server, etc. and it may mean a variety of devices equipped with a user terminal including equipment of every kind, a communication device including a communication modem, etc. for communication with a wired/wireless communication network, a memory for storing various kinds of programs and data for decoding an image or performing intra or inter prediction for decoding, a microprocessor for executing a program and performing operation and control and others.

In addition, an image encoded as a bitstream by an encoder may be transmitted to an image decoding device, decoded and reconstructed and reproduced as an image through a variety of communication interface such as a cable, an universal serial bus (USB), etc. or through a wired or wireless communication network, etc. such as the Internet, a wireless local area network, a wireless LAN network, a Wi-Bro network, a mobile communication network, etc. in real time or in non-real time. Alternatively, a bitstream generated by an encoder may be stored in a memory. The memory may include both a volatile memory and a non-volatile memory. In this specification, a memory may be expressed as a recoding medium storing a bitstream.

Commonly, a video may be configured with a series of pictures and each picture may be partitioned into coding units like a block. In addition, a person with ordinary skill in the art to which this embodiment pertains may understand that a term of picture entered below may be used by being substituted with other term having the same meaning as an image, a frame, etc. And, a person with ordinary skill in the art to which this embodiment pertains may understand that a term of coding unit may be used by being substituted with other term having the same meaning as a unit block, a block, etc.

Hereinafter, in reference to attached drawings, an embodiment of the present disclosure is described in more detail. In describing the present disclosure, an overlapping description is omitted for the same component.

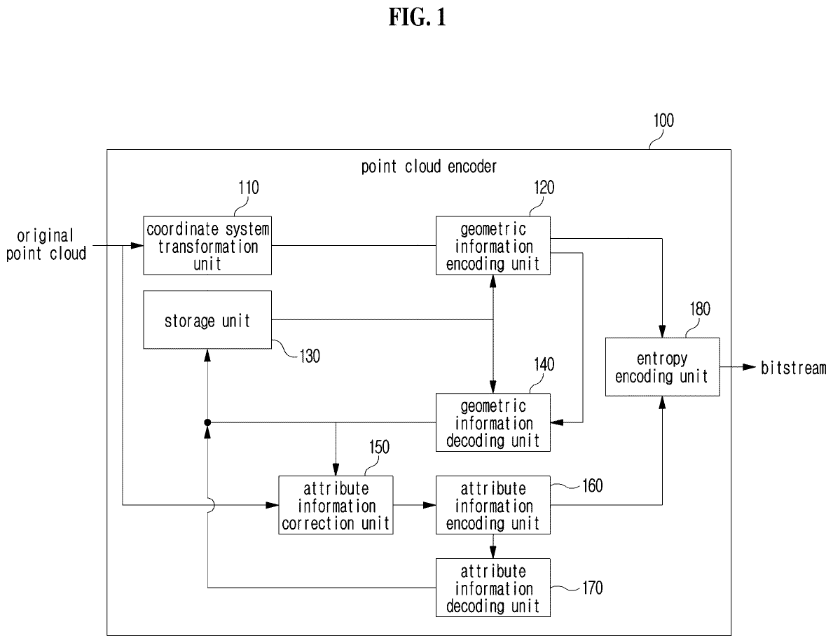

FIG. 1 is a block diagram illustrating an example of a point cloud encoder according to one embodiment of the present disclosure.

Referring to FIG. 1, the point cloud encoder (100) may include a coordinate system transformation unit (110), a geometric information encoding unit (120), a storage unit (130), a geometric information decoding unit (140), an attribute information correction unit (150), an attribute information encoding unit (160), an attribute information decoding unit (170), and an entropy encoding unit (180). The point cloud encoder (100) illustrated in FIG. 1 is an example, and the present disclosure is not limited thereto, and the point cloud encoder (100) may be implemented by adding other configurations in addition to the configuration illustrated in FIG. 1 or by omitting some of the configurations illustrated in FIG. 1.

The point cloud encoder (100) may receive an original point cloud and perform encoding to generate a bitstream. The point cloud may be a point cloud content expressed as a point cloud, which is a collection of points located in a three-dimensional space, and may be referred to as point cloud video data, etc. The point cloud according to the embodiments of the present disclosure may include one or more frames. One frame represents a still image/picture. Accordingly, the point cloud may include a point cloud image/frame/picture, and may be referred to as any one of a point cloud image, frame, and picture.

In the present disclosure, a point cloud may include one or more frames. In addition, point cloud data may include geometric information and/or attribute information. Geometric information may include position information of a point. Attribute information may include information indicating an attribute of a point. As an example, attribute information may include information regarding texture information, color (YCbCr or RGB), reflectivity, transparency, etc. of a point.

The coordinate system transformation unit (110) may perform coordinate system transformation by receiving information of the original point cloud. The original point cloud may be acquired from one or more cameras. In this case, since the coordinate system of each camera may be different, the coordinate system transformation of the points may be performed based on the position coordinate of each camera. The coordinate system transformation may be performed on the points of the point cloud video acquired from each camera to generate one point cloud data. Accordingly, point cloud content representing one wide range may be generated, or point cloud content having a high density of points may be generated.

As an example, coordinate system transformation may mean transformation from a world coordinate system to a frame coordinate system. Alternatively, it may mean transformation from an orthogonal coordinate system to a cylindrical or spherical coordinate system. Alternatively, it may mean transformation from a cylindrical or spherical coordinate system to an orthogonal coordinate system. The coordinate system-transformed geometric information may be transmitted to a geometric information encoding unit (120).

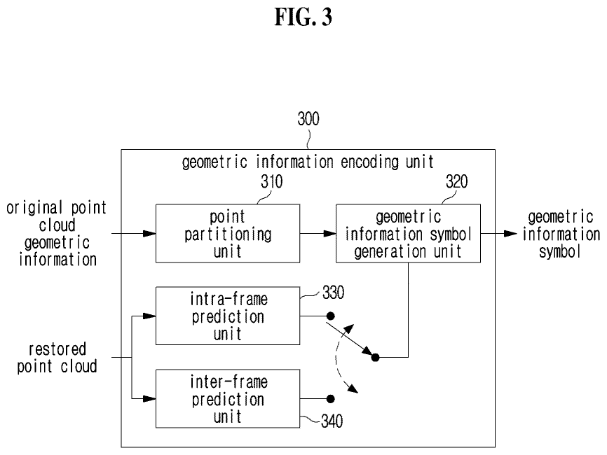

The geometric information encoding unit (120) may receive geometric information and a restored point cloud and encode them to generate geometric information-related symbols. The generated geometric information-related symbols may be transmitted to the entropy encoding unit (180) and the geometric information decoding unit (140). The geometric information encoding unit (120) will be described in detail later in FIG. 3.

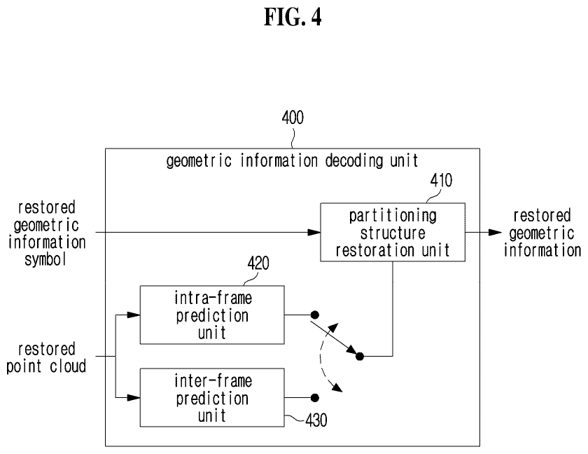

The geometric information decoding unit (140) may receive geometric information-related symbols and the restored point cloud and decode them to restore the geometric information of the point cloud. The restored geometric information may be transmitted to the attribute information correction unit (150). In addition, it may be transmitted to the storage unit (130) together with the restored point cloud attribute information. The geometric information decoding unit (140) will be described in detail later in FIG. 4.

The attribute information correction unit (150) may receive restored geometric information and the original point cloud, correct the attribute information, and then transfer the corrected attribute information to the attribute information encoding unit (160). Here, the attribute information correction may be a process of correcting the attribute information by considering an error due to encoding/decoding of the geometric information. In this case, a new point may be created or removed during the geometric information encoding/decoding process. In this case, a process of newly assigning attribute information according to the restored geometric information based on the attribute information of the original point cloud may be performed. As an example, the attribute information may be assigned as a value calculated using the attribute information of nearby points based on the distance between the current point and the points of the original point cloud.

The attribute information encoding unit (160) may encode attribute information of a point cloud using the input restored geometric information and corrected attribute information, and generate symbols related to the attribute information. The generated attribute information-related symbols may be transferred to the entropy encoding unit (180). In addition, the attribute information-related symbols may be transferred to the attribute information decoding unit (170).

The entropy encoding unit (180) may entropy-encode the received geometric information and attribute information-related symbols to generate a bitstream. The generated bitstream may be output from the point cloud encoder (100).

The attribute information decoding unit (170) may decode the input attribute information-related symbols to restore the point cloud attribute information. The restored attribute information may be transferred to the storage unit (130) together with the restored geometric information.

The storage unit (130) may store geometric information and attribute information of the input restored point cloud. The stored point cloud may be transmitted to the geometric information encoding unit (120) and the geometric information decoding unit (140).

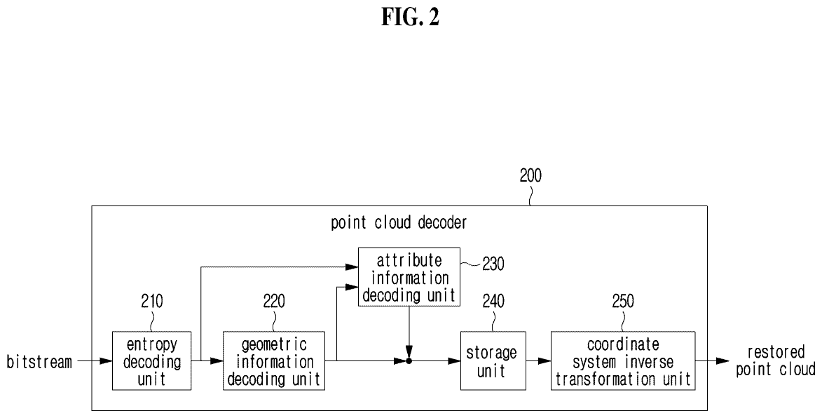

FIG. 2 is a block diagram illustrating an example of a point cloud decoder according to one embodiment of the present disclosure.

Referring to FIG. 2, the point cloud decoder (200) may include an entropy decoding unit (210), a geometric information decoding unit (220), an attribute information decoding unit (230), a storage unit (240), and a coordinate system inverse transformation unit (250). The point cloud decoder (200) illustrated in FIG. 2 is an example, and the present disclosure is not limited thereto, and the point cloud decoder (200) may be implemented by adding other components in addition to the components illustrated in FIG. 2 or by omitting some of the components illustrated in FIG. 1. In addition, the point cloud decoder (200) of FIG. 2 may perform substantially the same operation as the point cloud encoder (100) of FIG. 1. In this regard, any description overlapping with FIG. 1 will be omitted.

The point cloud decoder may receive a bitstream and perform decoding to restore the point cloud.

The entropy decoding unit (210) may receive a bitstream and decode it to restore the geometric information and attribute information-related symbols of the point cloud. The restored geometric information-related symbols may be transferred to the geometric information decoding unit (220). In addition, the restored attribute information-related symbols may be transferred to the attribute information decoding unit (230).

The geometric information decoding unit (220) may receive and decode restored geometric information-related symbols and the restored point cloud to restore geometric information of the point cloud. The restored geometric information may be transferred to the storage unit (240) in the form of a restored point cloud together with the attribute information decoding unit and the restored attribute information.

The attribute information decoding unit (230) may receive restored attribute information-related symbols and restored geometric information and decode them to restore the attribute information. The restored attribute information may be stored in the storage unit (240) in the form of a restored point cloud together with the restored geometric information.

The storage unit (240) may store the restored point cloud received. Thereafter, the stored point cloud may be transferred to the geometric information decoding unit (220) for the next point decoding. In addition, the restored point cloud may be transferred to the coordinate system inverse transformation unit (250) for output.

The coordinate system inverse transformation unit (250) may output (or render) by performing coordinate system inverse transformation on the geometric information of the input restored point cloud. Here, the coordinate system inverse transformation may be the reverse process of the coordinate system transformation performed by the point cloud encoder. In this case, the coordinate system inverse transformation may be performed based on the information received from the point cloud encoder (100).

FIG. 3 is a block diagram showing an example of a geometric information encoding unit according to one embodiment of the present disclosure.

Referring to FIG. 3, the geometric information encoding unit (300) may include a point partitioning unit (310), a geometric information symbol generation unit (320), an intra-frame prediction unit (330), and an inter-frame prediction unit (340). The geometric information encoding unit (300) illustrated in FIG. 3 is an example, and the present disclosure is not limited thereto, and the geometric information encoding unit (300) may be implemented by adding other configurations in addition to the configuration illustrated in FIG. 3 or by omitting some of the configurations illustrated in FIG. 3. The geometric information encoding unit (300) of FIG. 3 may be an example of the geometric information encoding unit (120) of FIG. 1 described above.

The geometric information encoding unit (300) may receive geometric information of the original point cloud and the restored point cloud and encode them to generate a geometric information symbol.

The point partitioning unit (310) may receive geometric information of the original point cloud and partition the points. In this case, the point partitioning may be a step of recursively partitioning a three-dimensional volume based on a binary tree, a quad tree, or an octree.

Here, the last node of the partitioned tree structure may be a three-dimensional cubic space having a 1×1×1 volume. In the present disclosure, the last node of such a partitioned tree structure may be referred to as a voxel. A voxel may mean a minimum unit expressing location information in a three-dimensional space. Points of a point cloud according to embodiments of the present disclosure may be included in one or more voxels. Groups of points in a three-dimensional space may be matched with voxels. As an example, a binary tree, a quad tree, or an octree partitioning structure may express points matched to voxels based on a binary, quad, or octree structure, respectively.

As an example, when partitioning according to a binary tree, quad tree or octree partitioning structure, the partitioning may be performed until the leaf node of each tree structure becomes a voxel. In this case, in the process of performing the recursive partitioning, whether at least one point is included in the node may be considered. That is, additional partitioning may not be performed for nodes that do not include at least one point.

The partitioned point cloud may be transmitted to the geometric information symbol generation unit (320). That is, the point partitioning unit (310) may mean a process of converting and expressing coordinate values in a three-dimensional space into a tree structure.

The intra-frame prediction unit (330) may receive the restored point cloud as input, generate a predicted statistical value for the occupancy information of the current point, and transmit it to the geometric information symbol generation unit (320). Here, the predicted statistical value may be a probability value for whether the current point occupies the current location. Alternatively, it may be a probability value for a flag for whether to partition among the partitioning information generated in the process of being partitioned into a tree structure. The predicted statistical value of the present disclosure is a value used to generate a geometric information symbol representing occupancy information, and is not limited to its name, and may also be referred to as prediction, statistics, probability, prediction value, statistics value, probability value, occupancy prediction, occupancy statistics, occupancy probability, occupancy prediction value, occupancy statistics value, occupancy probability value, context, occupancy context, etc.

The inter-frame prediction unit (340) may perform global motion compensation and/or local motion compensation on the input restored point cloud, generate a predicted statistical value using compensated points around the current point, and transfer the predicted statistical value to the geometric information symbol generation unit (320).

The geometric information symbol generation unit (320) may receive a partitioned point cloud and the predicted statistical value and generate a geometric information symbol for the current point. The generated geometric information symbol may be output.

FIG. 4 is a block diagram showing an example of a geometric information decoding unit according to one embodiment of the present disclosure.

Referring to FIG. 4, the geometric information decoding unit (400) may include a partitioning structure restoration unit (410), an intra-frame prediction unit (420), and an inter-frame prediction unit (430). The geometric information decoding unit (400) illustrated in FIG. 4 is an example, and the present disclosure is not limited thereto, and the geometric information decoding unit (400) may be implemented by adding other components in addition to the components illustrated in FIG. 4, or by omitting some of the components illustrated in FIG. 4. The geometric information decoding unit (400) of FIG. 4 may be an example of the geometric information decoding unit (140) of FIG. 1 and the geometric information decoding unit (220) of FIG. 2, which were described above.

In addition, the geometric information decoding unit (400) of FIG. 4 may perform substantially the same operation as the geometric information encoding unit (300) of FIG. 3. In this regard, any description overlapping with FIG. 3 will be omitted.

The geometric information decoding unit (400) may receive and decode the restored geometric information symbol and the restored point cloud to restore the geometric information of the point cloud.

The intra-frame prediction unit (420) may receive the restored point cloud, generate an intra-frame predicted statistical value for occupancy information of the current point, and transmit them to the partitioning structure restoration unit (410).

The inter-frame prediction unit (430) may perform global motion compensation and local motion compensation on the input restored point cloud, generate a predicted statistical value using compensated points around the current point, and transmit them to the partitioning structure restoration unit (410).

The partitioning structure restoration unit (410) may restore the tree partitioning structure using the restored geometric information symbol and the predicted statistic value received. As an example, the partitioning structure restoration unit (410) may be a geometric information restoration unit or a geometric information generation unit. The geometric information of the restored points according to the tree structure may be output.

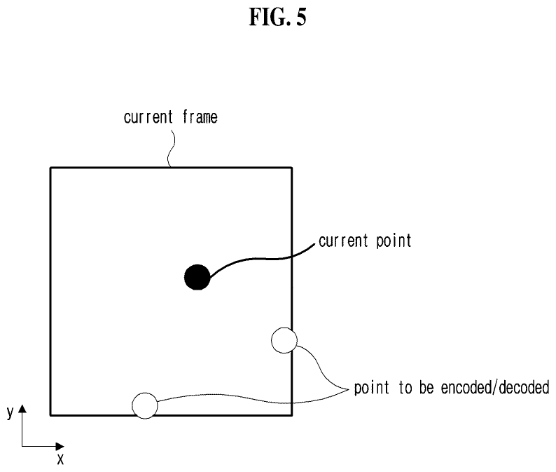

FIG. 5 is a drawing showing an example of expressing a point in three-dimensional space in two dimensions according to one embodiment of the present disclosure.

Referring to the example of FIG. 5, three circles (or dots) in FIG. 5 each represent a point. The current point and a point to be encoded/decoded may be included in the current frame. In the present disclosure, the point to be encoded/decoded may mean a point that is encoded/decoded after the current point according to the encoding/decoding order.

Each point exists at a specific location within the current frame, and the coordinate values of the point may be expressed as real numbers. In this case, since the point cloud does not exist at all locations, unlike a general image, there may be many limitations in using information about the restored points around when using encoding/decoding.

In addition, in the case of general images/videos, if the starting position is determined, such as the upper left or lower right, encoding/decoding may be performed sequentially, but in the case of point clouds, it is difficult to determine the order for all points, and since the original point cloud data is in the form of general text and the geometric information and attribute information of the points are listed, there is a problem that the order of the points does not match the spatial order. To solve this, even if the order is given by spatial location, there may be a mismatch between the distance in the order and the distance in space because not all spaces are filled.

Therefore, in order to solve these problems, in order to more efficiently express the position information of the point in the process of geometric information encoding/decoding, the position information of the point may be expressed as a voxel, which is a volume having a size of 1×1×1, using a tree structure. As described above, a voxel may mean a minimum unit expressing position information in a three-dimensional space. The points of the point cloud according to the embodiments of the present disclosure may be included in one or more voxels. Groups of points in a three-dimensional space may be matched with voxels. In this case, a voxel is a concept similar to a pixel of an image/video, but may additionally have information on whether it is occupied.

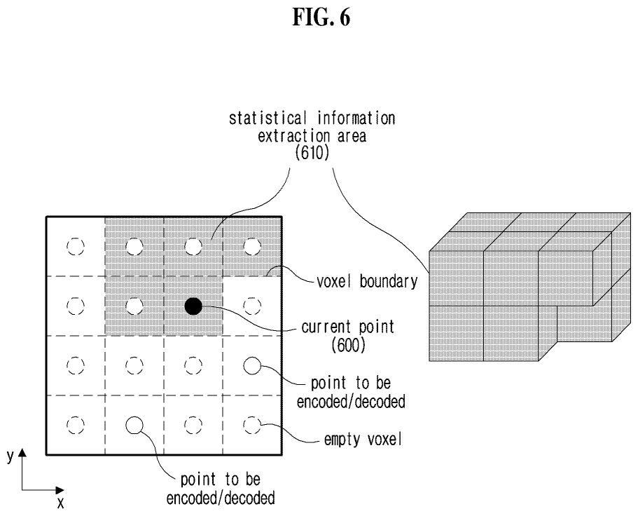

FIG. 6 is a diagram showing an example of statistical value prediction of a surrounding point performed by an intra-frame prediction unit according to one embodiment of the present disclosure.

Referring to FIG. 6, the current frame may be divided into a plurality of voxels having a size of 1×1×1. Each voxel may have occupancy information for a point. In this case, since encoding occupancy information for all voxels results in low encoding efficiency, occupancy information may be efficiently encoded through a recursive tree partitioning structure.

In one embodiment of the present disclosure, a predicted statistical value for the current point (610) may be calculated (or derived) based on the occupancy information of the surrounding voxel of the current point (610).

As an example, the predicted statistical value for the current point (600) may be derived based on the points included in the statistical information extraction area (610).

The statistical information extraction area (610) may be a shaded area in FIG. 6 that represents an area for obtaining predicted statistical values. In addition, the three-dimensional area in the right picture of FIG. 6 may be an area in which the statistical information extraction area (610) expressed in two dimensions is expressed in three-dimensional space.

The symbol of the current point (600) may be determined according to the occupancy ratio of the points included in the statistical information extraction area (610). In other words, the predicted statistical value for the current point (600) may be determined according to the occupancy ratio of the points included in the statistical information extraction area (610), and a symbol representing the occupancy information for the current point (600) may be generated based on this.

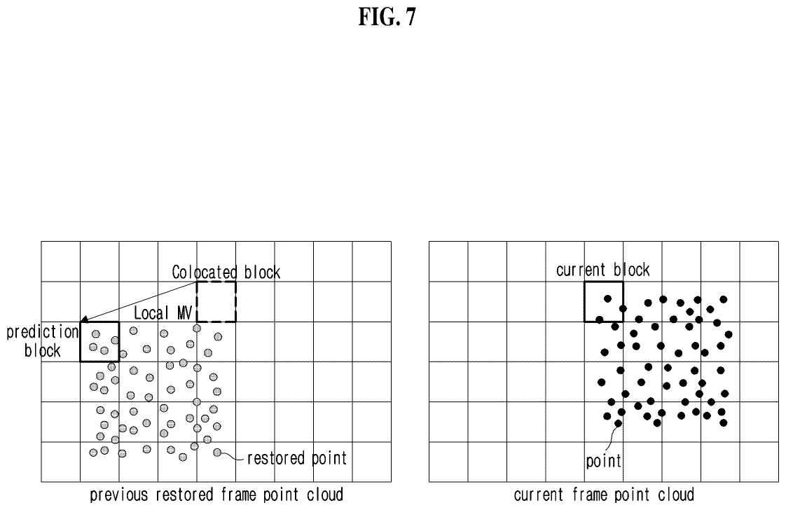

FIG. 7 is a diagram showing an example of local motion compensation performed in an inter-frame prediction unit according to one embodiment of the present disclosure. FIG. 7 may be a two-dimensional representation of a three-dimensional space for convenience of representation.

Referring to FIG. 7, as described above, the inter-frame prediction unit may first perform global motion compensation for the previous frame, and then perform local motion compensation. Global motion compensation may represent motion compensation at a higher level, and local motion compensation may represent motion compensation at a lower level. For example, global motion compensation may be performed at a frame level, and local motion compensation may be performed at a block (or may be referred to as a processing unit, a prediction unit, or a voxel) level within a frame.

In this case, the current frame and the previous frame may be divided into multiple blocks for local motion compensation. Local motion compensation may be performed individually for the divided blocks.

The motion information used for motion compensation may be transmitted to the decoder through the entropy encoder. The decoder may receive the information and perform local motion compensation in the same way as the encoder. As an example, the motion information may be in the form of a motion vector as in the example of FIG. 7. Alternatively, it may be in the form of a matrix used for three-dimensional coordinate system transformation.

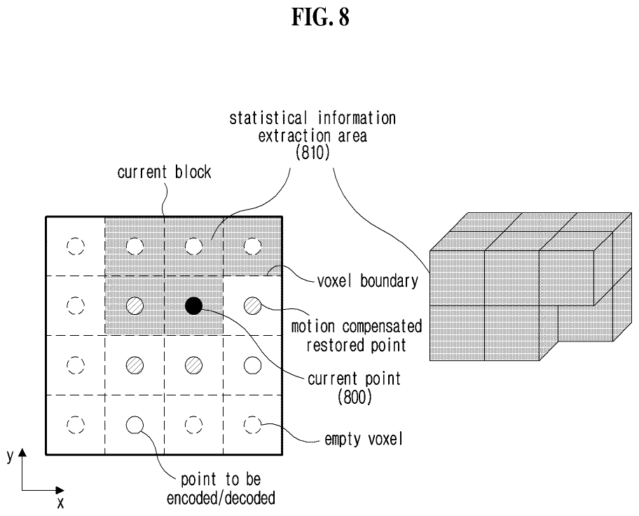

FIG. 8 is a diagram showing an example of a method for generating a predicted statistical value using motion-compensated points in an inter-frame prediction unit according to an embodiment of the present disclosure.

Referring to FIG. 8, local motion-compensated points (points indicated by hatching) may exist around a current point (800).

In this case, the predicted statistical value may be obtained based on the occupancy information of compensated points around the current point (800) in the statistical information extraction area (810) of FIG. 8.

As an example, the predicted statistical value may be calculated based on the number of restored points included in the statistical information extraction area (810). For example, the predicted statistical value may be derived as a ratio of the number of points that may be included in the statistical information extraction area (810) and the number of points currently included.

As an example, referring to the example of the left figure of FIG. 8, the number of points that may be included in the statistical information extraction area (810) is 5, and the number of restored points currently included is 1, in which case the predicted statistical value may be derived as 0.2.

Alternatively, as an example, if a maximum of 11 points may be included in the statistical information extraction area (810) expressed in three dimensions, as in the example of the right figure of FIG. 8, the predicted statistical value may be derived as 1/11. As another example, the predicted statistical value may be calculated by applying the distance between the position of the current point (800) and the positions of the points that may be included in the statistical information extraction area (810) as a weight. In this case, various known distance calculation methods such as the Manhattan distance, the Euclidean distance, and the Hamming distance may be used. Thereafter, the predicted statistical value may be obtained by dividing the sum of the weights of the restored points included in the statistical information extraction area (810) by the sum of all weights.

The predicted statistical value may be used for entropy encoding/decoding in the subsequent entropy encoding/decoding units. As an example, the entropy encoding/decoding unit may use the predicted statistical value as a probability value for a symbol representing whether the current point (800) is occupied.

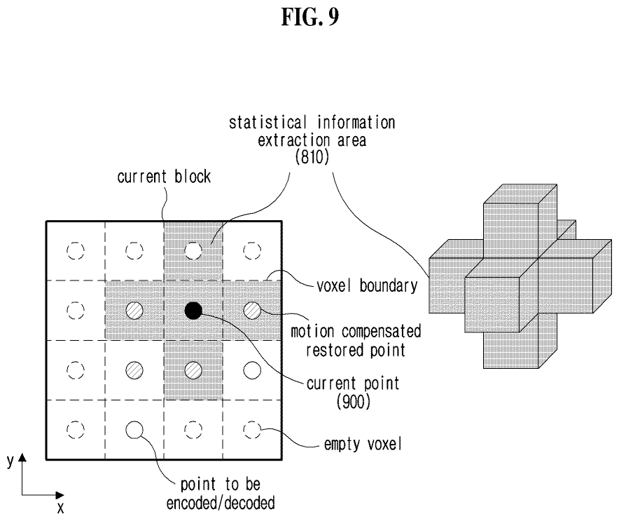

FIG. 9 is a diagram illustrating an example of a method for generating a predicted statistical value using motion-compensated points in an inter-frame prediction unit according to one embodiment of the present disclosure.

Referring to FIG. 9, local motion-compensated points (points indicated by hatching) may exist around the current point.

The predicted statistical value may be obtained based on the occupancy information of the compensated points around the current point (900) in the statistical information extraction area (910) of FIG. 9. In this case, since the motion compensated points may exist in all surroundings centered around the current point regardless of the encoding/decoding order of the current point (900), the statistical information extraction area (910) as shown in FIG. 9 may be defined.

Based on the two-dimensional area of the left picture of FIG. 9, the statistical information extraction area (910) may include surrounding points of the upper, lower, left, and right, and based on the three-dimensional area of the right picture of FIG. 9, the statistical information extraction area (910) may include surrounding points of the upper, lower, left, right, front, and back.

The predicted statistical value may be obtained through the surrounding occupancy information included in the statistical information extraction area (910) as illustrated in FIG. 9.

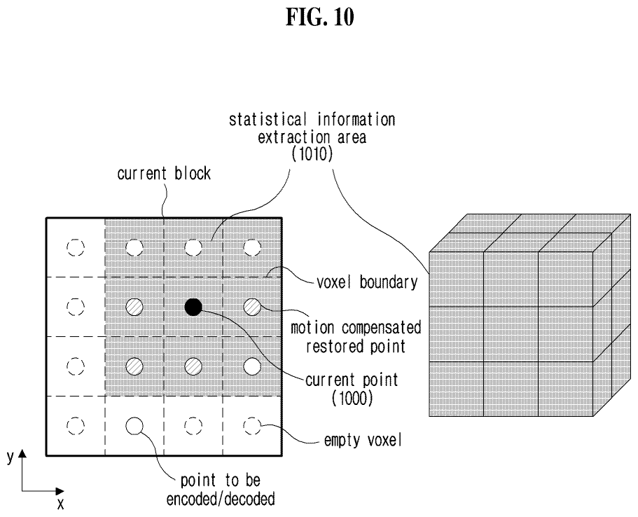

FIG. 10 is a diagram showing an example of a method for generating a predicted statistical value using motion compensated points in an inter-frame prediction unit according to an embodiment of the present disclosure.

Referring to FIG. 10, local motion compensated points (points indicated by hatching) may exist around the current point.

The predicted statistical value may be obtained based on the occupancy information of compensated points around the current point (1000) in the statistical information extraction area (1010) of FIG. 10.

In this case, since the motion compensated points may exist in all surroundings centered on the current point regardless of the encoding/decoding order of the current point, a statistical information extraction area (1010) as illustrated in FIG. 10 may be defined.

Based on the two-dimensional area of the left picture of FIG. 10, the statistical information extraction area (1010) may include surrounding points of the upper, lower, left, right, upper left, upper right, lower left, and lower right, and based on the three-dimensional area of the right picture of FIG. 10, the statistical information extraction area (1010) may include surrounding points of a hexahedral area.

The predicted statistical value may be obtained through the occupancy information of the area included in the statistical information extraction area (1010) as illustrated in FIG. 10.

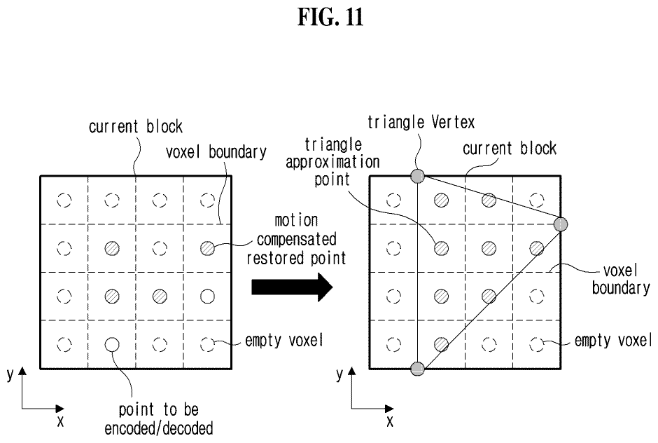

FIG. 11 is a diagram showing an example of a method for generating a triangle for inter-frame prediction according to one embodiment of the present disclosure.

Referring to FIG. 11, local motion compensated points (points indicated by hatching) may exist as shown in the left figure of FIG. 11. In this case, the motion compensated points may not exist exactly overlapping the current point, and may not exist all around the current point. This may reduce the encoding efficiency for point occupancy information.

To solve this, according to one embodiment of the present disclosure, as shown in the right figure of FIG. 11, a triangle may be generated based on motion-compensated points within the current block, and voxels overlapping (overlapping) with the triangle are considered to occupy points, so that local motion-compensated points may be approximated as faces of the triangle.

In this case, triangle vertices may be generated based on points close to the corners of the current block, and triangles may be generated by connecting the vertices of the generated triangles. The number of triangles may be determined according to the number of vertices of the generated triangles.

As an example, when multiple triangles are generated, the order of the vertices may be determined based on the positions of the vertices in the three-dimensional space. For example, the order of the vertices may be determined by projecting the vertices onto the x-y, y-z, and z-x planes, determining one plane based on the area of a rectangular surface generated from the vertices, and determining the order of the vertices projected onto the plane based on the clockwise direction. Alternatively, the order may be determined based on the counterclockwise direction. Thereafter, multiple triangles may be generated by connecting the vertices according to the determined order.

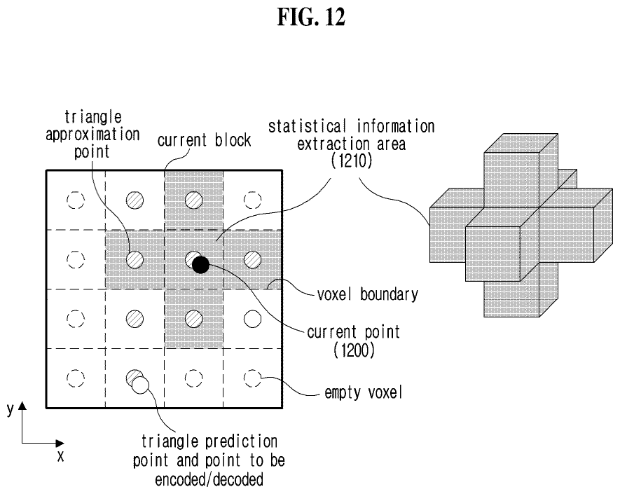

FIG. 12 is a diagram showing an example of a method for generating a predicted statistical value using motion-compensated points in an inter-frame prediction unit according to an embodiment of the present disclosure.

Referring to FIG. 12, the points indicated by hatching may be points generated through the triangle approximation described above in FIG. 11.

In this case, the predicted statistical value may be obtained based on the occupancy information of the compensated points around the current point (1200) in the statistical information extraction area (1210) of FIG. 12.

Here, the triangle approximation points may exist in all surroundings centered on the current point (1200) regardless of the order of encoding/decoding of the current point (1200). Therefore, as in the three-dimensional statistical information extraction area (1210) of the right figure of FIG. 12, the predicted statistical value may be obtained through the occupancy information of the surroundings (above, below, front, behind, left, and right) of the current point (1200).

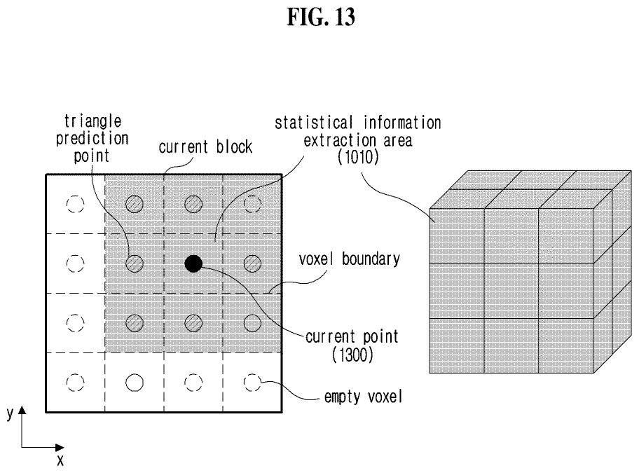

FIG. 13 is a diagram showing an example of a method for generating a predicted statistical value using motion-compensated points in an inter-frame prediction unit according to an embodiment of the present disclosure.

Referring to FIG. 13, points indicated by hatching may be points generated through the triangle approximation described above in FIG. 11.

The predicted statistical value may be obtained based on the occupancy information of compensated points around the current point (1300) in the statistical information extraction area (1310) of FIG. 13.

Here, the triangle approximation points may exist in all surroundings centered on the current point regardless of the order of encoding/decoding of the current point (1300). Therefore, the predicted statistical value may be obtained based on the occupancy information of the three-dimensional statistical information extraction area (1310) of the right figure of FIG. 13 and the hexahedral area centered on the current point (1300).

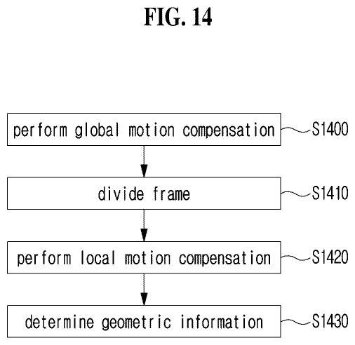

FIG. 14 is a flowchart illustrating a point cloud compression method according to one embodiment of the present disclosure.

Referring to FIG. 14, a point cloud compression device may perform global motion compensation based on a previous frame of a current frame (S1400).

The point cloud compression device may divide the current frame into a plurality of prediction units (S1410).

The point cloud compression device may determine a motion compensated point within the current prediction unit by performing local motion compensation on the current prediction unit (S1420).

The point cloud compression device may determine geometric information of the current point within the current prediction unit based on the motion compensated point (S1430).

As described above, the point cloud compression device may derive the predicted statistical value based on motion compensated points included in a predefined specific area around the current point, and determine geometric information of the current point based on the predicted statistical value.

In addition, as described above, the geometric information of the current point may include a symbol indicating whether the current point is occupied. The symbol indicating whether the current point is occupied may be entropy encoded using the predicted statistical value as a probability.

Additionally, as described above in FIGS. 9 and 12, the specific region around the current point may be defined as a region including voxels adjacent to the front, back, left, right, upper, and lower sides of the current point.

Additionally, as described above in FIGS. 10 and 13, the specific region around the current point may be defined as a hexahedral region centered on the current point and including adjacent voxels adjacent to the current point.

In addition, as described above with reference to FIGS. 11 to 13, the current prediction unit may be divided into at least one triangle based on the motion compensated point, and a point included in a plane of the divided triangle may be determined based on the motion compensated point. Geometric information of the current point may be determined based on at least one of the motion compensated point or the point included in the plane of the divided triangle. A plurality of vertices may be obtained based on a plurality of motion compensated points adjacent to corners of the current prediction unit, and the current prediction unit may be divided into the at least one triangle by connecting the plurality of vertices.

In addition, as described above, the current prediction unit may be divided into regions having a size of 1×1×1 based on a predefined tree structure, and the current point may correspond to a central position of the region having a size of 1×1×1. In this case, the predefined tree structure may include at least one of a binary tree, a quad tree, or an oct tree.

Embodiments described above may be a combination of components and features of the present disclosure in a predetermined form. Each component or feature should be considered selective unless explicitly stated otherwise. Each component or feature may be implemented in a form which is not combined with other component or feature. In addition, some components and/or features may be combined to configure an embodiment of the present disclosure. Order of operations described in embodiments of the present disclosure may be changed. Some configurations or features of an embodiment may be included in other embodiment or may be replaced with a configuration or a feature corresponding to other embodiment. It is obvious that claims without an explicit citation relationship in a scope of claims may be combined to configure an embodiment or may be included as a new claim by amendment after application.

An embodiment according to the present disclosure may be implemented by a variety of means, for example, hardware, firmware, software, or a combination thereof, etc. For implementation by hardware, an embodiment of the present disclosure may be implemented by one or more ASICs (application specific integrated circuits), DSPs (digital signal processors), DSPDs (digital signal processing devices), PLDs (programmable logic devices), FPGAs (field programmable gate arrays), processors, controllers, micro controllers, micro processors, etc.

In addition, for implementation by firmware or software, an embodiment of the present disclosure may be implemented in a form of a module, a procedure, a function, etc. performing functions or operations described above and may be recorded in a readable recoding medium through a variety of computer means. Here, a recording medium may include a program instruction, a data file, a data structure, etc. alone or in combination. A program instruction recorded in a recording medium may be those specially designed and configured for the present disclosure or those available by being notified to a person skilled in computer software. For example, a recording medium includes magnetic media such as a hard disk, a floppy disk and a magnetic tape, optical media such as CD-ROM (Compact Disk Read Only Memory) and DVD (Digital Video Disk), magneto-optical media such as a floptical disk and a hardware device which is specially configured to store and perform a program instruction such as ROM, RAM, a flash memory, etc. An example of a program instruction may include a high-level language code which may be executed by a computer by using an interpreter, etc. as well as a machine language code like what is made by a compiler. Such a hardware device may be configured to operate as at least one software module to perform an operation of the present disclosure and vice versa.

In addition, a device or a terminal according to the present disclosure may be driven by a command which causes at least one processor to perform functions and processes described above. For example, such a command may include, for example, an interpreted command like a script command such as a JavaScript or ECMAScript command, etc. or other commands stored in a computer readable medium readable or an executable code. Further, a device according to the present disclosure may be implemented in a distributed way across a network such as Server Farm or may be implemented in a single computer device.

In addition, a computer program which comes with a device according to the present disclosure and executes a method according to the present disclosure (also known as a program, software, a software application, a script or a code) may be written in any form of a programming language including a compiled or interpreted language or a priori or procedural language and may be deployed in any form including a stand-alone program, module, component or subroutine or other units suitable for use in a computer environment. A computer program does not necessarily correspond to a file of a file system. A program may be stored in a single file provided for a requested program, or in multiple interacting files (e.g., a file storing part of at least one module, subprogram or code), or in part of a file owning other program or data (e.g., at least one script stored in a markup language document). A computer program may be positioned in one site or distributed across a plurality of sites and may be deployed to be executed on one computer or multiple computers interconnected by a communication network.

It is obvious to a person skilled in the art that the present disclosure may be implemented in other specific form without departing from an essential feature of the present disclosure. Accordingly, the above-described detailed description should not be interpreted restrictively in all respects and should be considered illustrative. A scope of the present disclosure should be determined by reasonable interpretation of attached claims and all changes within an equivalent scope of the present disclosure are included in a scope of the present disclosure.

1. A method for compressing a point cloud, comprising:
performing global motion compensation based on a previous frame of a current frame;
dividing the current frame into a plurality of prediction units;
determining a motion compensated point within a current prediction unit by performing local motion compensation on the current prediction unit; and
determining geometric information of a current point within the current prediction unit based on the motion compensated point.

2. The method of claim 1, wherein determining the geometric information of the current point comprises:
deriving a predicted statistical value based on a motion compensated point included in a predefined specific area around the current point; and
determining the geometric information of the current point based on the predicted statistical value.

3. The method of claim 2, wherein the geometric information of the current point includes a symbol indicating whether the current point is occupied, and
wherein the symbol indicating whether the current point is occupied is entropy encoded using the predicted statistical value as a probability.

4. The method of claim 2, wherein the specific area around the current point is defined as an area including voxels adjacent to front, back, left, right, upper, and lower sides of the current point.

5. The method of claim 2, wherein the specific area around the current point is defined as a hexahedral area centered on the current point and including adjacent voxels adjacent to the current point.

6. The method of claim 1, further comprising:
dividing the current prediction unit into at least one triangle based on the motion compensated point; and
determining a point included in a plane of the divided triangle based on the motion compensated point.

7. The method of claim 6, wherein determining the geometric information of the current point comprises determining the geometric information of the current point based on at least one of the motion compensated point or a point included in the plane of the divided triangle.

8. The method of claim 6, wherein dividing into the at least one triangle comprises:
obtaining a plurality of vertices based on a plurality of motion compensated points adjacent to edges of the current prediction unit; and
dividing the current prediction unit into the at least one triangle by connecting the plurality of vertices.

9. The method of claim 1, wherein the current prediction unit is divided into areas having a size of 1×1×1 based on a predefined tree structure, and
wherein the current point corresponds to a central position of an area having the size of 1×1×1.

10. The method of claim 9, wherein the predefined tree structure includes at least one of a binary tree, a quad tree, or an oct tree.

11. A device for compressing a point cloud, comprising:
a processor configured to control the device; and
a memory coupled with the processor and configured to store data,
wherein the processor is configured to:
perform global motion compensation based on a previous frame of a current frame,
divide the current frame into a plurality of prediction units,
determine a motion compensated point within a current prediction unit by performing local motion compensation for the current prediction unit, and
determine geometric information of a current point within the current prediction unit based on the motion compensated point.
